(19) United States
(12) Patent Application Publication
(10) Pub. No.: US 2026/0126646 A1
(43) Pub. Date: May 7, 2026

(54) VEHICULAR CAMERA

(71) Applicant: Panasonic Automotive Systems Co., Ltd., Kanagawa (JP)

(72) Inventor: Futoshi SHIMIZU, Kanagawa (JP)

(73) Assignee: Panasonic Automotive Systems Co., Ltd., Kanagawa (JP)

(21) Appl. No.: 19/336,816

(22) Filed: Sep. 23, 2025

(30) Foreign Application Priority Data
Nov. 6, 2024 (JP) 2024-194561

(51) Int. Cl. G02B 27/00; G02B 7/02; G03B 17/55; G03B 30/00; H05B 3/84

(52) U.S. Cl. CPC G02B 27/0006; G02B 7/021; G03B 17/55; G03B 30/00; H05B 3/84

(57) ABSTRACT

A vehicular camera includes a lens barrel having a lens including at least a first lens and a second lens, an imaging element, a circuit board, a circuit board connector, a housing, and a connector. The first lens includes a first lens surface, a second lens surface, and a first lens side surface connecting the first and second lens surfaces. The second lens includes a third lens surface, a fourth lens surface, and a second lens side surface connecting the third and fourth lens surfaces. The second lens surface includes a first region through and a second region located outside the first region. The lens barrel includes a heater disposed along at least a part of the second region of the second lens surface, and a resin member disposed between the inner surface of the first tubular portion and the first lens side surface.

### TECHNICAL FIELD

The present disclosure relates to a vehicular camera.

With demands for improvements in vehicle safety, introduction of autonomous driving functions and the like in recent years, development of vehicular cameras that are mounted on vehicles and capture the inside and outside of the vehicles has become active (for example, see Patent Literature 1).

### CITATION LIST

### Patent Literature

Patent Literature 1: WO2019/225745

Patent Literature 2: WO2021/075372

### SUMMARY OF INVENTION

Required levels relating to safety, automatic driving functions, and the like, which are required for vehicles, are improved, and further improvement in performance and the like are also required for vehicular cameras.

The present disclosure relates to a technique for providing a new vehicular camera.

The present disclosure relates to a vehicular camera. The vehicular camera includes a lens barrel made of metal having a first tubular portion along an optical axis, and including a first end portion of the first tubular portion, a second end portion of the first tubular portion opposite to the first end portion, and a lens including at least a first lens and a second lens disposed along the optical axis; an imaging element disposed on the optical axis and closer to the second end portion than the first end portion of the first tubular portion of the lens barrel; a circuit board including a first surface and a second surface opposite to the first surface, the imaging element being disposed on the first surface; a circuit board connector disposed on the circuit board; a housing configured to support the lens barrel and accommodate the imaging element and the circuit board; and a connector disposed in at least a part of the housing and electrically connected to the circuit board connector. The first tubular portion of the lens barrel includes an inner surface and an outer surface, the first lens and the second lens of the lens barrel are disposed adjacent to each other, the first lens of the lens barrel is disposed farther, than the second lens, away from the first surface of the circuit board in a direction along the optical axis. The first lens of the lens barrel includes a first lens surface through which the optical axis passes, a second lens surface through which the optical axis passes and which is opposite to the first lens surface, and a first lens side surface connecting the first lens surface and the second lens surface. The second lens of the lens barrel includes a third lens surface through which the optical axis passes, a fourth lens surface through which the optical axis passes and which is opposite to the third lens surface, and a second lens side surface connecting the third lens surface and the fourth lens surface. The second lens surface of the first lens of the lens barrel includes a first region through which the optical axis passes, and a second region located outside the first region with respect to the optical axis to surround the first region. The lens barrel includes a heater having a first ring shape and disposed along at least a part of the second region of the second lens surface of the first lens, between a part of the second lens surface of the first lens and a part of the third lens surface of the second lens, and a resin member having a second ring shape and disposed between the inner surface of the first tubular portion and the first lens side surface of the first lens.

According to the present disclosure, since the resin member is disposed on the first lens side surface of the first lens, it is possible to prevent heat from the heater, which removes foreign matter such as raindrops and frozen objects adhering to the first lens, from directly diffusing to the lens barrel made of metal having a high thermal conductivity.

### BRIEF DESCRIPTION OF DRAWINGS

FIG. 1 is an example of a vehicle, and is a top view of the vehicle on which vehicular cameras are mounted;

FIG. 2 is a block diagram illustrating a connection example of the vehicular cameras provided in the vehicle illustrated in FIG. 1, a camera ECU, and a display;

FIG. 3 is another example of the vehicle, and is a schematic diagram of a cabin of the vehicle on which a vehicular camera is mounted;

FIG. 4 is a top view of the vehicle in FIG. 3;

FIG. 5 is a block diagram illustrating a connection example of the vehicular camera provided in the vehicle illustrated in FIG. 3, a camera ECU, and a display device;

FIG. 6 is a front perspective view of the vehicular camera according to a first embodiment;

FIG. 7 is an exploded perspective view of the vehicular camera according to the first embodiment;

FIG. 8 is a top view of the vehicular camera according to the first embodiment;

FIG. 9 is a perspective view illustrating a cross section, taken along a line I-I in FIG. 8, of a vicinity of a first end portion of a lens barrel of the vehicular camera according to the first embodiment;

FIG. 10 is an exploded perspective view of a vehicular camera according to a second embodiment;

FIG. 11 is a cross-sectional view of the vehicular camera according to the second embodiment taken along the line I-I in FIG. 8;

FIG. 12 is a cross-sectional view of the vehicular camera according to the second embodiment taken along a line II-II in FIG. 8;

FIG. 13 is an enlarged view of a region A in FIG. 12;

FIG. 14 is a perspective view illustrating a cross section, taken along the line I-I in FIG. 8, of a vicinity of a first end portion of a lens barrel of the vehicular camera according to the second embodiment; and

FIG. 15 is a cross-sectional view taken along the line I-I in FIG. 8 in a modification of the vehicular camera.

### DESCRIPTION OF EMBODIMENTS

Hereinafter, embodiments that specifically disclose a vehicular camera according to the present disclosure will be described in detail with reference to the drawings as appropriate. However, unnecessarily detailed descriptions may be omitted. For example, detailed descriptions of already well-known matters and redundant descriptions of substantially the same configuration may be omitted. This is to avoid unnecessary redundancy of the following descriptions and to facilitate understanding of those skilled in the art. It should be noted that the accompanying drawings and the following description are provided for those skilled in the art to sufficiently understand the present disclosure, and are not intended to limit the subject matter described in the claims.

(Vehicle on which Vehicular Cameras are Mounted)

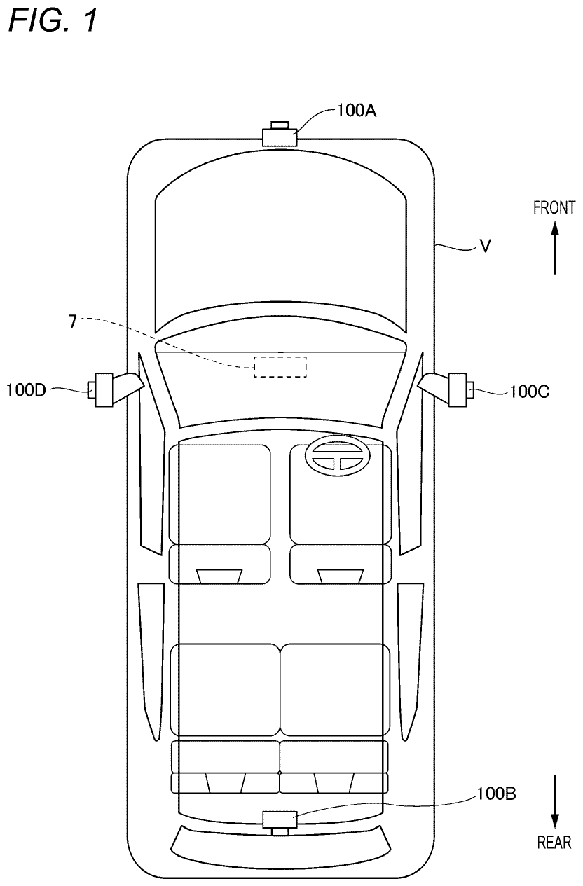

FIG. 1 is an example of a vehicle, and is a top view of the vehicle on which vehicular cameras are mounted. As a vehicular camera 100, a vehicular camera 100A, a vehicular camera 100B, a vehicular camera 100C, and a vehicular camera 100D are mounted on a vehicle V. The vehicular camera 100A is a front camera, the vehicular camera 100B is a rear camera, the vehicular camera 100C is a right side camera, and the vehicular camera 100D is a left side camera. The vehicular cameras 100A to 100D are, for example, wide-angle cameras having an angle of view of about 180°, and are disposed to capture images showing an entire periphery of the vehicle V.

For example, the vehicular camera 100A is provided in a front grille of the vehicle V, and captures an image of a front region in a direction of looking down obliquely with respect to the ground. The vehicular camera 100B is provided in a roof spoiler of the vehicle V, and captures an image of a rear region in a direction of looking down obliquely with respect to the ground. The vehicular camera 100C and the vehicular camera 100D are provided in side mirrors of the vehicle V, and capture images of lateral regions in directions of looking down obliquely with respect to the ground, respectively.

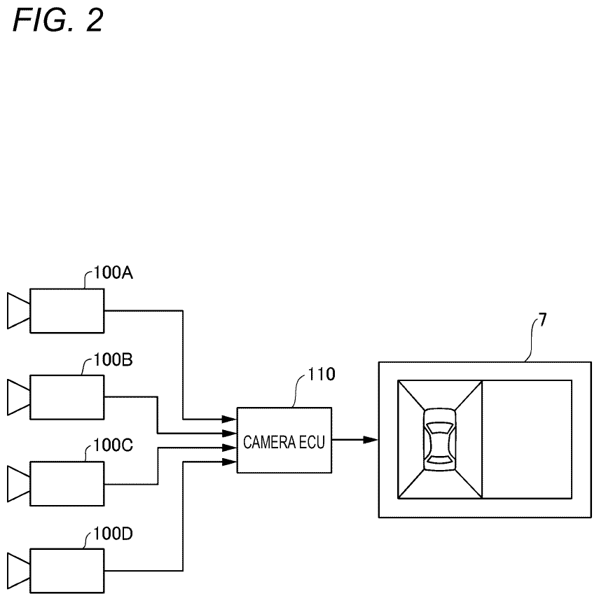

FIG. 2 is a block diagram illustrating a connection example of the vehicular cameras 100A to 100D provided in the vehicle V illustrated in FIG. 1, a camera ECU 110, and a display 7. The camera electronic control unit (ECU) 110 in FIG. 2 synthesizes the images captured by the vehicular cameras 100A to 100D, and displays a synthesized image on the display 7 of a navigation system disposed on an instrument panel, for example. An occupant can visually recognize the display 7 and check a situation around the vehicle V.

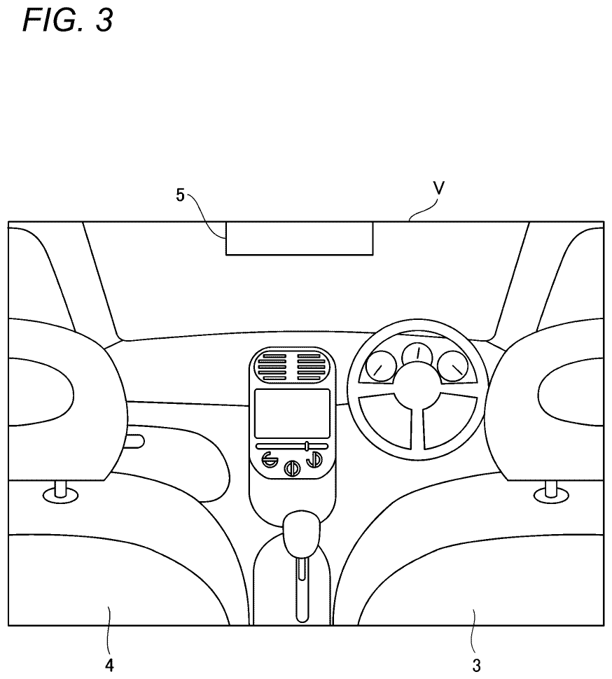

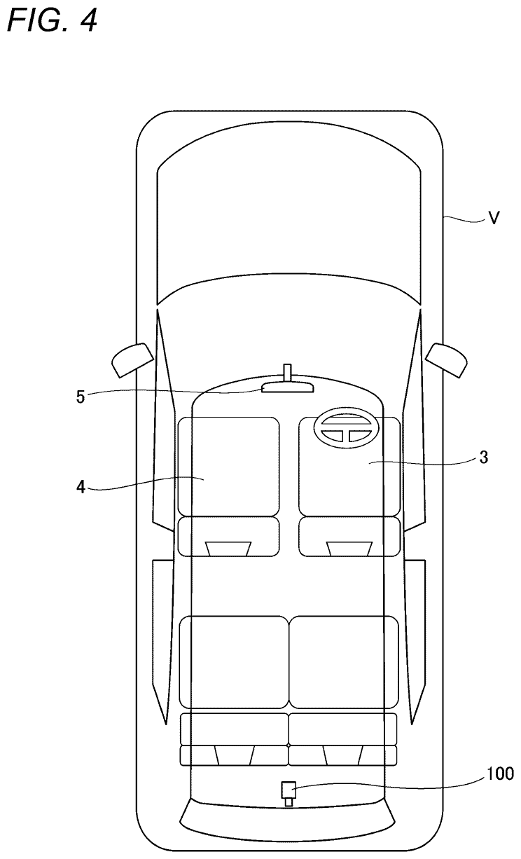

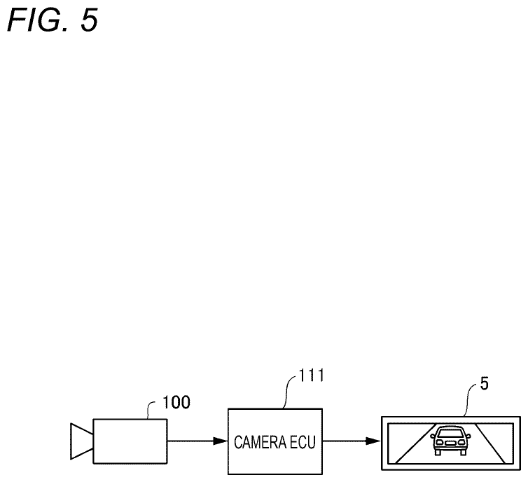

FIG. 3 is another example of the vehicle, and is a schematic diagram of a cabin of the vehicle on which the vehicular camera is mounted, and FIG. 4 is a top view of the vehicle in FIG. 3. The vehicle V includes a display device 5 (for example, an electronic rearview mirror) at an attachment position of a rearview mirror, which is a front portion between a driver's seat 3 and a passenger seat 4 in a cabin 2. Further, the vehicle V is provided with the vehicular camera 100 at a rear side of a vehicle body. FIG. 5 is a block diagram illustrating a connection example of the vehicular camera 100 provided in the vehicle V illustrated in FIG. 3, a camera ECU 111, and the display device 5. The camera electronic control unit (ECU) 111 in FIG. 4 processes an image captured by the vehicular camera 100, and the display device 5 displays the image. The occupant can visually recognize the display device 5 and check a rear situation of the vehicle V.

### (First Embodiment of Vehicular Camera)

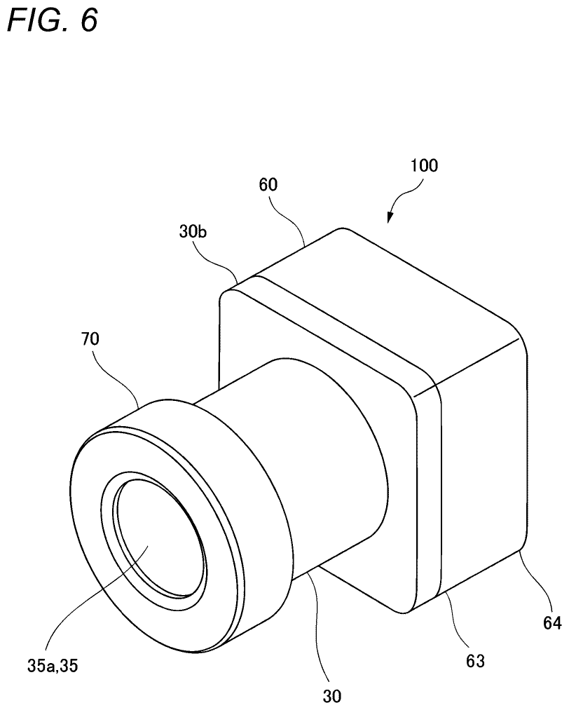

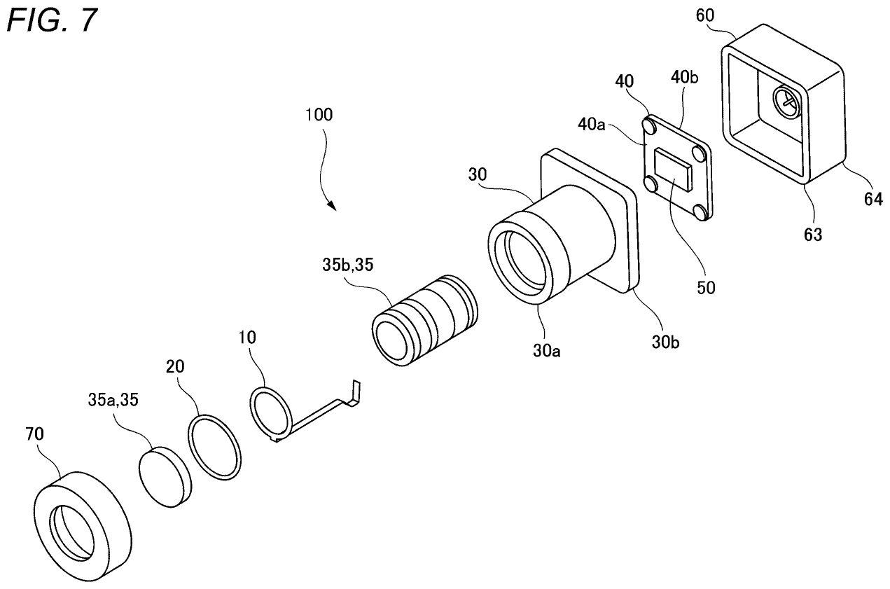

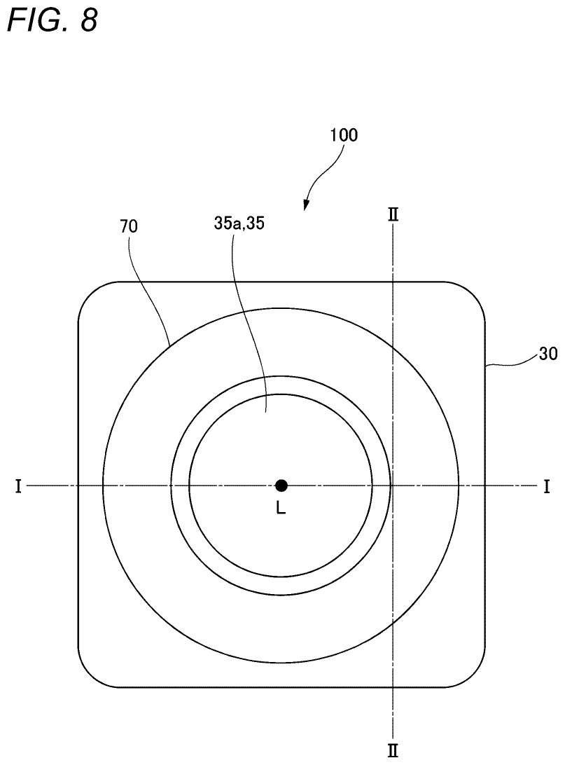

FIG. 6 is a front perspective view of the vehicular camera 100 according to a first embodiment. FIG. 7 is an exploded perspective view of the vehicular camera 100 according to the first embodiment. FIG. 8 is a top view of the vehicular camera 100 according to the first embodiment. Coordinates including an X axis along one side of the vehicular camera 100, a Y axis orthogonal to the X axis and along another side of the vehicular camera 100, and a Z axis orthogonal to the X axis and the Y axis and along a height direction of the vehicular camera 100 are defined, and are used in the following description.

The vehicular camera 100 according to the present embodiment includes a lens barrel 30, a circuit board 40, an imaging element 50, and a housing 60.

The lens barrel 30 made of metal has a first tubular portion along an optical axis L (a direction orthogonal to the sheet of FIG. 8 and along the Z axis), and has a first end portion 30a of the first tubular portion and a second end portion 30b opposite to the first end portion 30a in a direction along the optical axis L. The lens barrel 30 has an inner surface 33 and an outer surface 34. The inner surface 33 corresponds to an inner surface of the first tubular portion of the lens barrel 30, and has a cylindrical surface in the present embodiment. The inner surface 33 may have a stepped portion instead of a flat surface. The outer surface 34 is located farther outward than the inner surface 33 with respect to the optical axis L. The outer surface 34 corresponds to an outer surface of the first tubular portion of the lens barrel 30, and has a cylindrical surface in the present embodiment.

The first end portion 30a forms a distal end portion of the lens barrel 30, and at least a part of the second end portion 30b faces the circuit board 40 inside the first housing 60.

The lens barrel 30 has, at a position radially inward of the inner surface 33, a lens 35 that is accommodated inside the first tubular portion and includes at least a first lens 35a and a second lens 35b disposed on the optical axis L. The respective lenses are arranged in a state in which respective optical axes L are aligned with each other, and constitute a lens group used for capturing images of the inside and outside of the vehicle body of the vehicle V. As will be described later, the lens 35 may include lenses other than the first lens 35a and the second lens 35b.

The imaging element 50 is disposed in an internal space of the housing 60 on the optical axis L and closer to the second end portion 30b than the first end portion 30a of the first tubular portion of the lens barrel 30. The imaging element 50 is electrically connected to a circuit of the circuit board 40, and can capture an image by directing external light to the imaging element 50. The imaging element 50 may be, for example, a complementary metal-oxide-semiconductor (CMOS) image sensor.

The circuit board 40 is disposed in the internal space of the housing 60, and includes a first surface 40a and a second surface 40b opposite to the first surface 40a. However, two or more circuit boards may be provided. The imaging element 50 is disposed on the first surface 40a of the circuit board 40.

The circuit board 40 has a first shape in a plan view. The first shape in a plan view is a shape when viewed in a direction from the first surface 40a to the second surface 40b of the circuit board 40. The first shape is, for example, a quadrangular shape as in the embodiment, but may be a polygonal shape having five or more sides.

The housing 60 is a tubular member having the internal space, and serves to support the lens barrel 30 while accommodating at least the circuit board 40 and the imaging element 50. The housing 60 has a second tubular portion along the optical axis L, and includes a third end portion 63 and a fourth end portion 64. The third end portion 63 is connected to the lens barrel 30. The fourth end portion 64 is opposite to the third end portion 63 in the direction along the optical axis L, and is disposed farther away from the first end portion 30a of the lens barrel 30 than the third end portion 63. In the present embodiment, the housing 60 has a rectangular tubular shape, but is not limited thereto, and may have a polygonal tubular shape other than the rectangular tubular shape, a circular or elliptical tubular shape, or another tubular shape.

In a state in which the housing 60 accommodates at least the circuit board 40 and the imaging element 50, the second end portion 30b of the lens barrel 30 and the third end portion 63 of the housing 60 are welded. The welding is performed by, for example, laser welding.

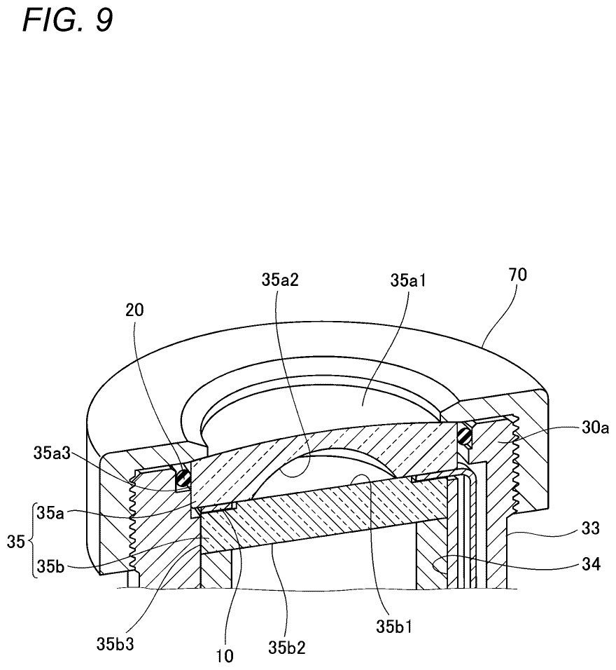

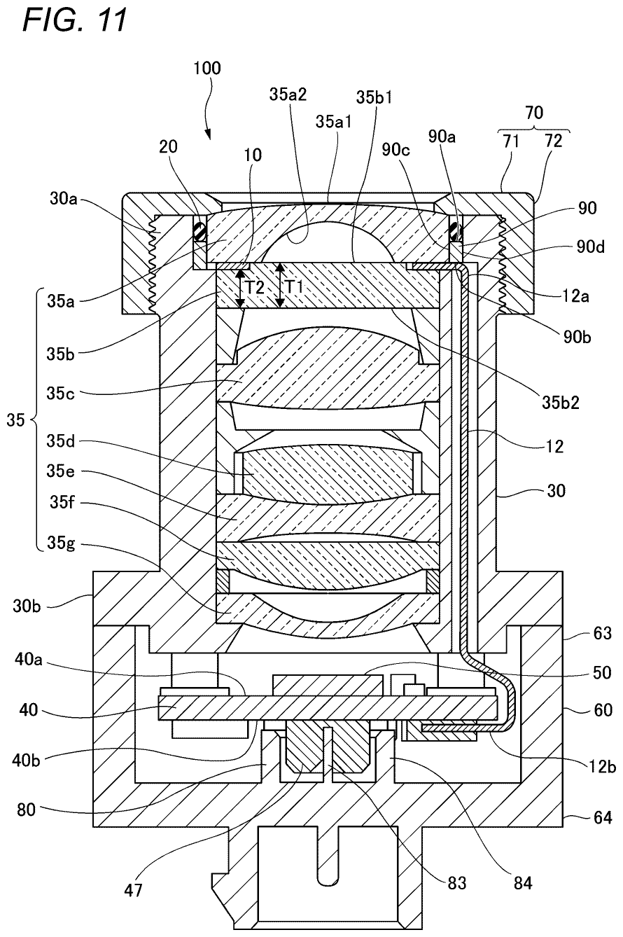

Next, the first lens 35a and the second lens 35b of the lens barrel 30 will be described again. FIG. 9 illustrates a cross section, taken along a line I-I in FIG. 8, of a vicinity of the first end portion 30a of the lens barrel 30. The first lens 35a and the second lens 35b are disposed adjacent to each other in the direction along the optical axis L. In the exploded perspective view of FIG. 7, the first lens 35a of the lens 35 is drawn independently, and the second lens 35b and other lenses (for example, a third lens 35c, a fourth lens 35d, a fifth lens 35e, a sixth lens 35f, and a seventh lens 35g in FIG. 11 of the second embodiment to be described later) are drawn integrally.

The first lens 35a of the lens barrel 30 is disposed farther, than the second lens 35b, away from the first surface 40a of the circuit board 40 in the direction along the optical axis L. The first lens 35a has a first lens surface 35a1 through which the optical axis L passes, a second lens surface 35a2 through which the optical axis L passes and which is opposite to the first lens surface 35a1, and a first lens side surface 315a3 connecting the first lens surface 35a1 and the second lens surface 35a2.

The second lens 35b of the lens barrel 30 is disposed closer to the first surface 40a of the circuit board 40 than the first lens 35a in the direction along the optical axis L. The second lens 35b has a third lens surface 35b1 through which the optical axis L passes, a fourth lens surface 35b2 through which the optical axis L passes and which is opposite to the third lens surface 35b1, and a second lens side surface 315b3 connecting the third lens surface 35b1 and the fourth lens surface 35b2.

The lens barrel 30 further includes a heater 10. The heater 10 is disposed along at least a part of a second region of the second lens surface 35a2 of the first lens 35a, between a part of the second lens surface 35a2 of the first lens 35a and a part of the third lens surface 35b1 of the second lens 35b in the vicinity of the first end portion 30a of the lens barrel 30, and has a first ring shape.

The heater 10 is a member for removing foreign matter such as raindrops and frozen objects adhering to the first lens 35a exposed to the outside by heat generation and securing a field of view of the vehicular camera 100. The heater 10 may be, for example, a positive temperature coefficient (PTC) heater. The PTC heater can perform self-temperature control and reduce power consumption. The heater 10 may be, for example, a metal heater.

The vehicular camera 100 according to the present embodiment further includes a holding member 70 made of resin, which is provided around the first end portion 30a of the lens barrel 30 and has a third tubular shape. Since the holding member 70 contacts the first end portion 30a of the lens barrel 30 and a peripheral edge of the first lens surface 35a1 of the first lens 35a, the first lens 35a can be reliably held by the lens barrel 30.

The vehicular camera 100 according to the present embodiment further includes an elastic member 20 disposed between a first portion 71 of the holding member 70 and a first resin surface 90a of a resin member 90 and between the first lens side surface 315a3 of the first lens 35a and the inner surface 33 of the first tubular portion of the lens barrel 30.

### (Second Embodiment of Vehicular Camera)

With demands for higher pixel counts of the imaging element 50, the vehicular camera 100 is required to have higher processing accuracy and higher optical accuracy. In order to satisfy such demands, the lens barrel 30 is made of metal. When the lens barrel 30 is made of metal, it is easier to achieve higher processing accuracy than when the lens barrel 30 is made of resin or the like.

However, when the lens barrel 30 is made of metal, the function of the heater 10 may be deteriorated. That is, since a part of the lens barrel 30 made of metal is adjacent to the first lens 35a, in particular, the first lens side surface 315a3 of the first lens 35a, the heat from the heater 10 is likely to escape to the lens barrel 30 made of metal having a high thermal conductivity before the foreign matter of the first lens 35a is removed, and the function of removing the foreign matter may not be sufficiently exhibited. The first lens 35a is typically made of materials with a lower thermal conductivity than metal, such as glass or resin.

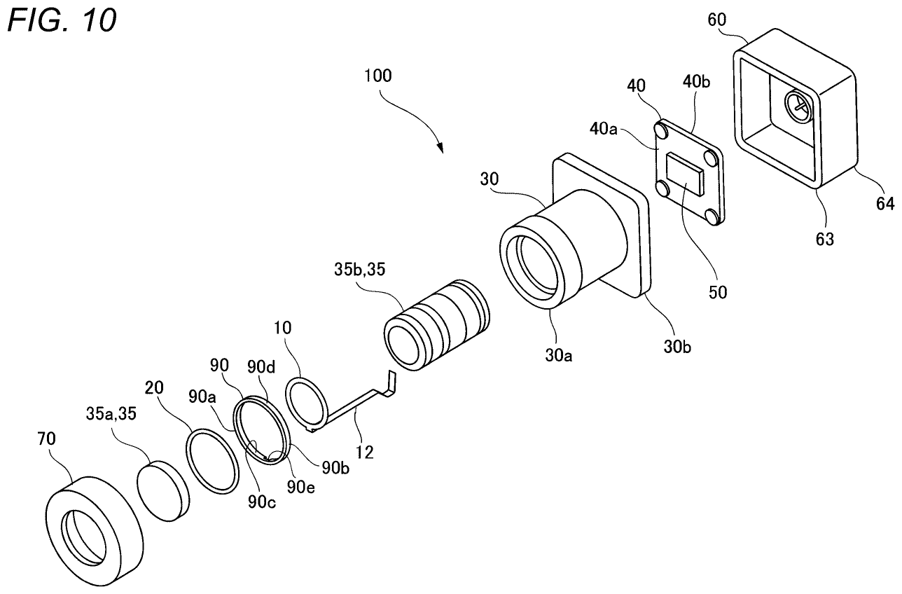

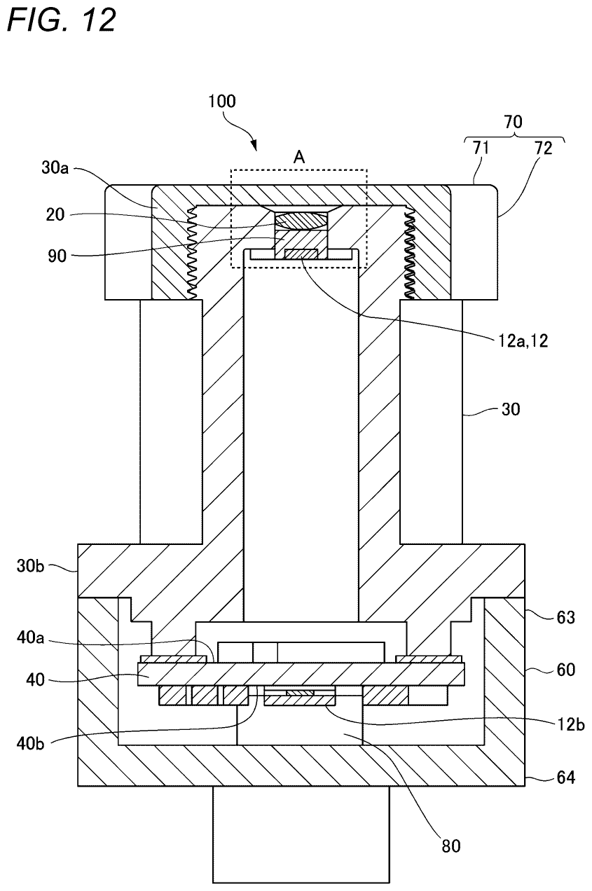

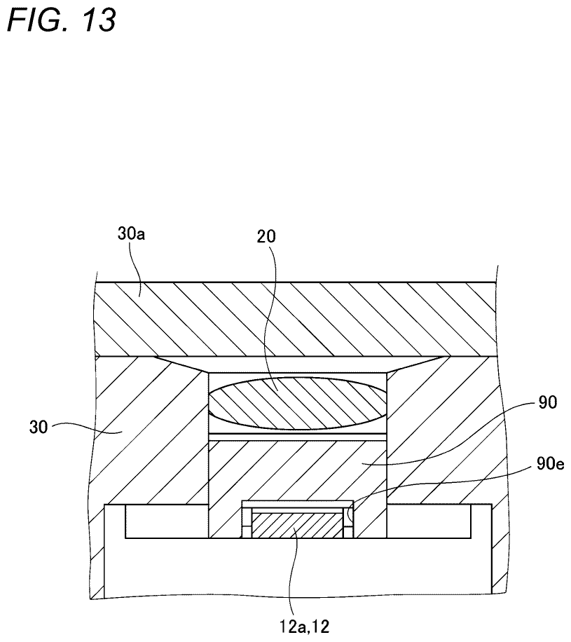

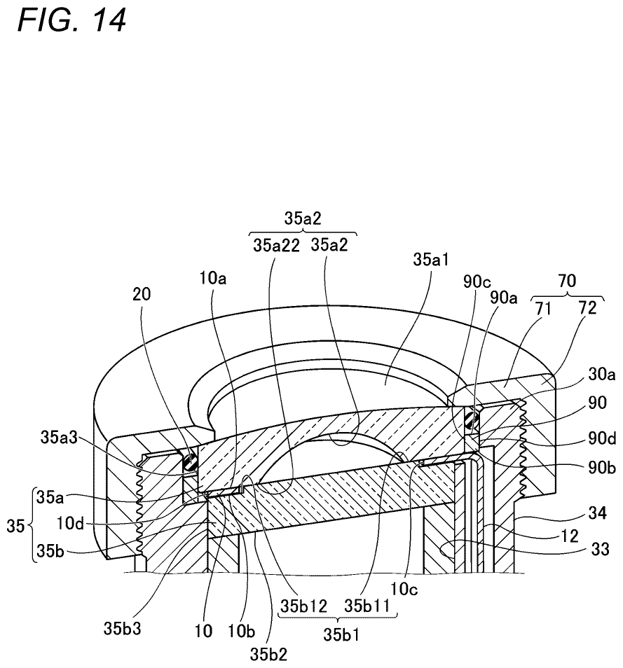

The vehicular camera according to the second embodiment addresses the above-described problem. FIG. 10 is an exploded perspective view of the vehicular camera 100 according to the second embodiment. FIG. 11 is a cross-sectional view of the vehicular camera 100 according to the second embodiment taken along the line I-I in FIG. 8. FIG. 12 is a cross-sectional view of the vehicular camera 100 according to the second embodiment taken along a line II-II in FIG. 8. FIG. 13 is an enlarged view of a region A in FIG. 12. FIG. 14 is a perspective view illustrating a cross section, taken along the line I-I in FIG. 8, of a vicinity of the first end portion 30a of the lens barrel 30 of the vehicular camera 100 according to the second embodiment.

The appearance of the vehicular camera 100 according to the second embodiment is the same as the appearance in the first embodiment in FIGS. 6 and 8. The cross-sectional view of FIG. 11 is not illustrated in the first embodiment, but is common to the first embodiment in that the lens 35 includes the first lens 35a, the second lens 35b, the third lens 35c, the fourth lens 35d, the fifth lens 35e, the sixth lens 35f, and the seventh lens 35g. In the exploded perspective view of FIG. 10, similarly to FIG. 7, the first lens 35a of the lens 35 is drawn independently, and the second lens 35b, the third lens 35c, the fourth lens 35d, the fifth lens 35e, the sixth lens 35f, and the seventh lens 35g are drawn integrally.

The first lens 35a and the second lens 35b are also common to the first embodiment. In particular, the second lens surface 35a2 of the first lens 35a includes a first region 35a21 through which the optical axis L passes, and a second region 35a22 located outside the first region 35a21 with respect to the optical axis L and surrounding the first region 35a21. The third lens surface 35b1 of the second lens 35b includes a third region 35b11 through which the optical axis L passes and a fourth region 35b12 located outside the third region 35b11.

In the vehicular camera 100 according to the second embodiment, the resin member 90 is provided in the lens barrel 30. The resin member 90 is disposed between the inner surface 33 of the first tubular portion of the lens barrel 30 and the first lens side surface 35a3 of the first lens 35a, and has a second ring shape. Since the resin member 90 is made of resin, a thermal conductivity thereof is lower than that of the lens barrel 30 made of metal.

Since the resin member 90 with a low thermal conductivity is disposed on the first lens side surface 35a3 of the first lens 35a, it is possible to prevent the heat from the heater 10, which removes foreign matter such as raindrops and frozen objects adhering to the first lens 35a, from directly diffusing to the lens barrel 30 made of metal having a high thermal conductivity. Therefore, the foreign matter of the first lens 35a can be removed before the heat from the heater 10 escapes to the lens barrel 30, and the field of view of the vehicular camera 100 can be secured.

The resin member 90 having the second ring shape includes the first resin surface 90a, a second resin surface 90b opposite to the first resin surface 90a, a resin inner surface 90c connecting the first resin surface 90a and the second resin surface 90b, and a resin outer surface 90d located outside the resin inner surface 90c with respect to the optical axis L and connecting the first resin surface 90a and the second resin surface 90b. At least a part of the resin inner surface 90c of the resin member 90 contacts the first lens side surface 35a3 of the first lens 35a, and at least a part of the resin outer surface 90d of the resin member 90 contacts the inner surface 33 of the first tubular portion of the lens barrel 30.

Accordingly, since the resin member 90 contacts the first lens side surface 35a3 of the first lens 35a and contacts the inner surface 33 of the lens barrel 30, it is possible to effectively prevent the heat from the heater 10 from diffusing to the lens barrel 30 made of metal and to stably dispose the resin member 90.

The heater 10 having the first ring shape of the lens barrel 30 is also common to the first embodiment. The heater 10 having the first ring shape includes a first heater surface 10a, a second heater surface 10b opposite to the first heater surface 10a, a heater inner surface 10c connecting the first heater surface 10a and the second heater surface 10b, and a heater outer surface 10d located outside the heater inner surface 10c with respect to the optical axis L and connecting the first heater surface 10a and the second heater surface 10b. The first heater surface 10a of the heater 10 contacts at least a part of the second region 35a22 of the second lens surface 35a2 of the first lens 35a.

Accordingly, since the first heater surface 10a of the heater 10 contacts at least a part of the first lens 35a, raindrops, frozen objects, and the like on the first lens 35a can be efficiently removed.

The heater outer surface 10d of the heater 10 of the lens barrel 30 is spaced apart from the resin inner surface 90c of the resin member 90. Accordingly, the heater 10 can be disposed without the heater outer surface 10d of the heater 10 interfering with the resin inner surface 90c of the resin member 90.

As illustrated in FIG. 11, a first thickness T1, which is a thickness between the third region 35b11 of the third lens surface 35b1 of the second lens 35b and the fourth lens surface 35b2 of the second lens 35b, is larger than a second thickness T2 between the fourth region 35b12 of the third lens surface 35b1 of the second lens 35b and the fourth lens surface 35b2 of the second lens 35b.

Accordingly, it is possible to secure a space for disposing the heater 10 at a position corresponding to the fourth region 35b12 of the third lens surface 35b1 of the second lens 35b.

The heater 10 of the lens barrel 30 includes a conducting wire portion 12 including a first conducting wire end 12a and a second conducting wire end 12b opposite to the first conducting wire end 12a. The first conducting wire end 12a is connected to the heater, and the second conducting wire end 12b is electrically connected to the circuit board 40.

As illustrated in FIGS. 10 and 13, the resin member 90 has a resin notch portion 90e cut out from the resin inner surface 90c to the resin outer surface 90d in a part of the second resin surface 90b. A part of the conducting wire portion 12 of the heater 10 is disposed in the resin notch portion 90e of the resin member 90. Accordingly, even when the heater 10 is adjacent to the first lens 35a and the resin member 90, the conducting wire portion 12 that supplies power to the heater 10 can be efficiently disposed in the lens barrel 30. The resin notch portion 90e is not limited to the second resin surface 90b, and may be provided in a part of the first resin surface 90a.

The conducting wire portion 12 of the heater 10 of the lens barrel 30 passes between the inner surface 33 and the outer surface 34 of the first tubular portion of the lens barrel 30 and is electrically connected to the circuit board 40. Accordingly, the conducting wire portion 12 can be disposed in the lens barrel 30 using a space between the inner surface 33 and the outer surface 34 of the lens barrel 30. The conducting wire portion 12 may pass outside the outer surface 34 of the lens barrel 30 and be electrically connected to the circuit board 40.

The vehicular camera 100 according to the present embodiment further includes the holding member 70 made of resin, which is provided around the first end portion 30a of the lens barrel 30 and has a third tubular shape. The holding member 70 having a third tubular shape includes the first portion 71 that contacts the first end portion 30a of the first tubular portion of the lens barrel 30 and a peripheral edge of the first lens surface 35a1 of the first lens 35a, and a second portion 72 fixed to a part of the outer surface 34 of the first tubular portion of the lens barrel 30.

Accordingly, since the holding member 70 contacts the first end portion 30a of the lens barrel 30 and the peripheral edge of the first lens surface 35a1 of the first lens 35a, the first lens 35a can be reliably held by the lens barrel 30. The holding member 70 may be fixed to the lens barrel 30 by fitting with a screw. An adhesive may be provided between the holding member 70 and the outer surface of the lens barrel 30.

The vehicular camera 100 according to the present embodiment further includes the elastic member 20 disposed between the first portion 71 of the holding member 70 and the first resin surface 90a of the resin member 90 and between the first lens side surface 35a3 of the first lens 35a and the inner surface 33 of the first tubular portion of the lens barrel 30. Accordingly, it is possible to prevent foreign matter from entering the lens barrel 30 through a gap between the holding member 70 and the first lens 35a.

The elastic member 20 may be an O-ring. Accordingly, it is possible to easily prevent foreign matter from entering the lens barrel 30 through a gap between the holding member 70 and the first lens 35a.

As illustrated in FIG. 11, at least one lens 35 of the lens barrel 30 includes a plurality of lenses, and the heater 10 can heat the first lens 35a farthest from the imaging element 50 among the plurality of lenses 35. The heater 10 can remove raindrops, frozen objects, and the like on the first lens 35a that is farthest from the imaging element 50 and closest to the outside of the vehicular camera 100, and the field of view can be efficiently secured.

The vehicular camera 100 further includes a circuit board connector 47 and a connector 80. The circuit board connector 47 is disposed on the circuit board 40, particularly on the second surface 40b of the circuit board 40. The connector 80 is disposed in at least a part of the housing 60 and is electrically connected to the circuit board connector 47. External power is supplied to the circuit board 40 via the connector 80 and the circuit board connector 47.

When the vehicular camera 100 is disposed in the vehicle V, the connector 80 is electrically connected to a cable of the vehicle V. Accordingly, it is possible to secure power from the vehicle V.

The conducting wire portion 12 of the heater 10 may be a flexible printed circuit board. Accordingly, the conducting wire portion 12 can be easily formed.

In the vehicular camera 100 of the embodiment, the circuit board connector 47 is disposed on the second surface 40b of the circuit board 40. Accordingly, the electrical connection between the circuit board 40 and the connector 80 can be easily secured via the circuit board connector 47.

The connector 80 may be a coaxial connector having a signal terminal 83 and a ground terminal 84. Accordingly, the connector 80 can ensure both signal supply and grounding.

As described above, the housing 60 includes the third end portion 63 and the fourth end portion 64 opposite to the third end portion 63 and disposed farther away from the first end portion 30a of the lens barrel 30 than the third end portion 63. The third end portion 63 supports the lens barrel 30, and the connector 80 is disposed in at least a part of the fourth end portion 64 of the housing 60. Accordingly, the housing 60 can hold the connector 80 while supporting the lens barrel 30.

The material constituting the housing 60 is not particularly limited, but the housing 60 may be made of metal. Accordingly, the housing 60 can serve as a noise shield to shield noise inside and outside the vehicular camera 100.

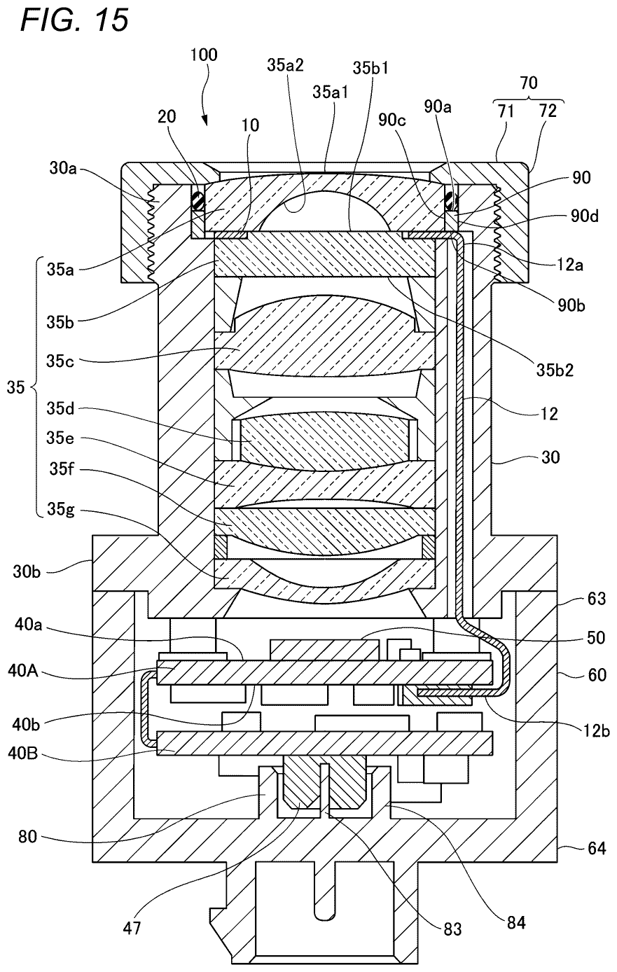

FIG. 15 is a cross-sectional view taken along the line I-I in FIG. 8 in a modification of the vehicular camera 100. In this example, the circuit board 40 includes a first circuit board 40A and a second circuit board 40B. Accordingly, components can be disposed on each of a plurality of circuit boards. The circuit board 40 may include three or more circuit boards.

As described above, at least the following matters are described in the present disclosure. Components corresponding to those in the embodiment are illustrated in parentheses, but the present disclosure is not limited thereto.

(1) A vehicular camera (vehicular camera 100) including:
a lens barrel (lens barrel 30) made of metal having a first tubular portion along an optical axis (optical axis L), and including a first end portion (first end portion 30a) of the first tubular portion, a second end portion (second end portion 30b) of the first tubular portion opposite to the first end portion, and a lens (lens 35) including at least a first lens (first lens 35a) and a second lens (second lens 35b) disposed along the optical axis;
an imaging element (imaging element 50) disposed on the optical axis and closer to the second end portion than the first end portion of the first tubular portion of the lens barrel;
a circuit board (circuit board 40) including a first surface (first surface 40a) and a second surface (second surface 40b) opposite to the first surface, the imaging element being disposed on the first surface;
a circuit board connector (circuit board connector 47) disposed on the circuit board;
a housing (housing 60) configured to support the lens barrel and accommodate the imaging element and the circuit board; and
a connector (connector 80) disposed in at least a part of the housing and electrically connected to the circuit board connector, in which
the first tubular portion of the lens barrel includes an inner surface (inner surface 33) and an outer surface (outer surface 34),
the first lens and the second lens of the lens barrel are disposed adjacent to each other,
the first lens of the lens barrel is disposed farther, than the second lens, away from the first surface of the circuit board in a direction along the optical axis,
the first lens of the lens barrel includes
a first lens surface (first lens surface 35a1) through which the optical axis passes,
a second lens surface (second lens surface 35a2) through which the optical axis passes and which is opposite to the first lens surface, and
a first lens side surface (first lens side surface 35a3) connecting the first lens surface and the second lens surface,
the second lens of the lens barrel includes
a third lens surface (third lens surface 35b1) through which the optical axis passes,
a fourth lens surface (fourth lens surface 35b2) through which the optical axis passes and which is opposite to the third lens surface, and
a second lens side surface (second lens side surface 35b3) connecting the third lens surface and the fourth lens surface,
the second lens surface of the first lens of the lens barrel includes
a first region (first region 35a21) through which the optical axis passes, and
a second region (second region 35a22) located outside the first region with respect to the optical axis to surround the first region, and
the lens barrel includes
a heater (heater 10) having a first ring shape and disposed along at least a part of the second region of the second lens surface of the first lens, between a part of the second lens surface of the first lens and a part of the third lens surface of the second lens, and a resin member (resin member 90) having a second ring shape and disposed between the inner surface of the first tubular portion and the first lens side surface of the first lens.

Accordingly, since the resin member is disposed on the first lens side surface of the first lens, it is possible to prevent heat from the heater, which removes foreign matter such as raindrops and frozen objects adhering to the first lens, from directly diffusing to the lens barrel made of metal having a high thermal conductivity.

(2) The vehicular camera according to (1), in which
the resin member having the second ring shape of the lens barrel includes
a first resin surface (first resin surface 90a),
a second resin surface (second resin surface 90b) opposite to the first resin surface,
a resin inner surface (resin inner surface 90c) connecting the first resin surface and the second resin surface, and
a resin outer surface (resin outer surface 90d) located outside the resin inner surface with respect to the optical axis and connecting the first resin surface and the second resin surface,
at least a part of the resin inner surface of the resin member contacts the first lens side surface of the first lens, and
at least a part of the resin outer surface of the resin member contacts the inner surface of the first tubular portion of the lens barrel.

Accordingly, since the resin member contacts the first lens side surface of the first lens and contacts the inner surface of the lens barrel, it is possible to effectively prevent the heat from the heater from diffusing to the lens barrel made of metal and to stably dispose the resin member.

(3) The vehicular camera according to (2), in which
the third lens surface of the second lens of the lens barrel has
a third region (third region 35b11) through which the optical axis passes, and
a fourth region (fourth region 35b12) located outside the third region,
the heater having the first ring shape of the lens barrel has
a first heater surface (first heater surface 10a),
a second heater surface (second heater surface 10b) opposite to the first heater surface,
a heater inner surface (heater inner surface 10c) connecting the first heater surface and the second heater surface, and
a heater outer surface (heater outer surface 10d) located outside the heater inner surface with respect to the optical axis and connecting the first heater surface and the second heater surface, and
the first heater surface of the heater contacts the at least a part of the second region of the second lens surface of the first lens.

Accordingly, since the first heater surface of the heater contacts at least a part of the first lens, raindrops, frozen objects, and the like on the first lens can be efficiently removed.

(4) The vehicular camera according to (3), in which the heater outer surface of the heater of the lens barrel is spaced apart from the resin inner surface of the resin member.

Accordingly, the heater can be disposed without the heater outer surface of the heater interfering with the resin inner surface of the resin member.

(5) The vehicular camera according to (4), in which
a first thickness that is a thickness between the third region of the third lens surface of the second lens and the fourth lens surface of the second lens is larger than a second thickness that is a thickness between the fourth region of the third lens surface of the second lens and the fourth lens surface of the second lens.

Accordingly, it is possible to secure a space for disposing the heater at a position corresponding to the fourth region of the third lens surface of the second lens.

(6) The vehicular camera according to (3), in which
the heater of the lens barrel includes a conducting wire portion (conducting wire portion 12) including a first conducting wire end (first conducting wire end 12a) and a second conducting wire end (second conducting wire end 12b) opposite to the first conducting wire end,
the first conducting wire end of the conducting wire portion is connected to the heater,
the second conducting wire end of the conducting wire portion is electrically connected to the circuit board,
the resin member has a resin notch portion (resin notch portion 90e) cut out from the resin inner surface to the resin outer surface in a part of the second resin surface, and
a part of the conducting wire portion is disposed in the resin notch portion of the resin member.

Accordingly, even when the heater is adjacent to the first lens and the resin member, it is possible to efficiently dispose the conducting wire portion that supplies power to the heater in the lens barrel.

(7) The vehicular camera according to (6), in which
the conducting wire portion of the heater of the lens barrel passes between the inner surface and the outer surface of the first tubular portion of the lens barrel and is electrically connected to the circuit board.

Accordingly, the conducting wire portion can be disposed in the lens barrel using a space between the inner surface and the outer surface of the lens barrel.

(8) The vehicular camera according to (1), further including:
a holding member (holding member 70) made of resin, the holding member being provided around the first end portion of the lens barrel and having a third tubular shape, in which
the holding member having the third tubular shape includes
the first portion (first portion 71) that contacts the first end portion of the first tubular portion of the lens barrel and a peripheral edge of the first lens surface of the first lens, and a second portion (second portion 72) fixed to a part of the outer surface of the first tubular portion of the lens barrel.

Accordingly, since the holding member contacts the first end portion of the lens barrel and the peripheral edge of the first lens surface of the first lens, the first lens can be reliably held by the lens barrel.

(9) The vehicular camera according to (8), further including:
an elastic member (elastic member 20) disposed between the first portion of the holding member and a first resin surface of the resin member and between the first lens side surface of the first lens and the inner surface of the first tubular portion of the lens barrel.

Accordingly, it is possible to prevent foreign matter from entering the lens barrel through a gap between the holding member and the first lens.

(10) The vehicular camera according to (9), in which the elastic member is an O-ring.

Accordingly, it is possible to easily prevent foreign matter from entering the lens barrel through a gap between the holding member and the first lens.

(11) The vehicular camera according to (1), in which
the first lens of the lens barrel is a lens farthest from the imaging element, and
the heater of the lens barrel is able to heat the first lens of the lens barrel.

Accordingly, the heater can remove raindrops, frozen objects, and the like on the first lens that is farthest from the imaging element and closest to the outside of the vehicular camera, and the field of view can be efficiently secured.

(12) The vehicular camera according to (1), in which
the heater of the lens barrel is a positive temperature coefficient (PTC) heater.

Accordingly, power consumption can be reduced.

(13) The vehicular camera according to (1), in which
when the vehicular camera is disposed in a vehicle, the connector is electrically connected to a cable of the vehicle.

Accordingly, it is possible to secure power from the vehicle.

(14) The vehicular camera according to (1), in which
the circuit board connector is disposed on the second surface of the circuit board.

Accordingly, the electrical connection between the circuit board and the connector can be easily secured via the circuit board connector.

(15) The vehicular camera according to (1), in which
the circuit board includes a first circuit board (first circuit board 40A) and a second circuit board (second circuit board 40B).

Accordingly, components can be disposed on each of a plurality of circuit boards.

(16) The vehicular camera according to (1), in which
the connector is a coaxial connector including a signal terminal (signal terminal 83) and a ground terminal (ground terminal 84).

Accordingly, the connector can ensure both signal supply and grounding.

(17) The vehicular camera according to (1), in which
the housing has a second tubular portion,
the housing includes
a third end portion (third end portion 63) of the second tubular portion, and
a fourth end portion (fourth end portion 64) of the second tubular portion opposite to the third end portion and disposed farther, than the third end portion of the second tubular portion, away from the first end portion of the first tubular portion of the lens barrel,
the third end portion of the second tubular portion supports the lens barrel, and
the connector is disposed in at least a part of the fourth end portion of the second tubular portion of the housing.

Accordingly, the housing can hold the connector while supporting the lens barrel.

(18) The vehicular camera according to (1), in which
the housing is made of metal.

Accordingly, the housing can serve as a noise shield.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiments described above may be combined freely in a range without departing from the gist of the invention.

### INDUSTRIAL APPLICABILITY

The present disclosure is useful for a vehicular camera capable of preventing heat from the heater, which removes foreign matter adhering to the first lens, from directly diffusing to the lens barrel made of metal having a high thermal conductivity and securing a field of view.

### CROSS-REFERENCE TO RELATED APPLICATIONS

This application is based on and claims priority under 35 USC 119 from Japanese Patent Application No. 2024-194561 filed on Nov. 6, 2024, the contents of which are incorporated herein by reference.

What is claimed is:

1. A vehicular camera comprising:
a lens barrel made of metal having a first tubular portion along an optical axis, and including a first end portion of the first tubular portion, a second end portion of the first tubular portion opposite to the first end portion, and a lens including at least a first lens and a second lens disposed along the optical axis;
an imaging element disposed on the optical axis and closer to the second end portion than the first end portion of the first tubular portion of the lens barrel;
a circuit board including a first surface and a second surface opposite to the first surface, the imaging element being disposed on the first surface;
a circuit board connector disposed on the circuit board;
a housing configured to support the lens barrel and accommodate the imaging element and the circuit board; and
a connector disposed in at least a part of the housing and electrically connected to the circuit board connector, wherein
the first tubular portion of the lens barrel includes an inner surface and an outer surface,
the first lens and the second lens of the lens barrel are disposed adjacent to each other,
the first lens of the lens barrel is disposed farther, than the second lens, away from the first surface of the circuit board in a direction along the optical axis,
the first lens of the lens barrel includes
a first lens surface through which the optical axis passes,
a second lens surface through which the optical axis passes and which is opposite to the first lens surface, and
a first lens side surface connecting the first lens surface and the second lens surface,
the second lens of the lens barrel includes
a third lens surface through which the optical axis passes,
a fourth lens surface through which the optical axis passes and which is opposite to the third lens surface, and
a second lens side surface connecting the third lens surface and the fourth lens surface,
the second lens surface of the first lens of the lens barrel includes
a first region through which the optical axis passes, and
a second region located outside the first region with respect to the optical axis to surround the first region, and
the lens barrel includes
a heater having a first ring shape and disposed along at least a part of the second region of the second lens surface of the first lens, between a part of the second lens surface of the first lens and a part of the third lens surface of the second lens, and
a resin member having a second ring shape and disposed between the inner surface of the first tubular portion and the first lens side surface of the first lens.

2. The vehicular camera according to claim 1, wherein
the resin member having the second ring shape of the lens barrel includes
a first resin surface,
a second resin surface opposite to the first resin surface,
a resin inner surface connecting the first resin surface and the second resin surface, and
a resin outer surface located outside the resin inner surface with respect to the optical axis and connecting the first resin surface and the second resin surface,
at least a part of the resin inner surface of the resin member contacts the first lens side surface of the first lens, and
at least a part of the resin outer surface of the resin member contacts the inner surface of the first tubular portion of the lens barrel.

3. The vehicular camera according to claim 2, wherein
the third lens surface of the second lens of the lens barrel has
a third region through which the optical axis passes, and
a fourth region located outside the third region,
the heater having the first ring shape of the lens barrel has
a first heater surface,
a second heater surface opposite to the first heater surface,
a heater inner surface connecting the first heater surface and the second heater surface, and
a heater outer surface located outside the heater inner surface with respect to the optical axis and connecting the first heater surface and the second heater surface, and
the first heater surface of the heater contacts the at least a part of the second region of the second lens surface of the first lens.

4. The vehicular camera according to claim 3, wherein
the heater outer surface of the heater of the lens barrel is spaced apart from the resin inner surface of the resin member.

5. The vehicular camera according to claim 4, wherein
a first thickness that is a thickness between the third region of the third lens surface of the second lens and the fourth lens surface of the second lens is larger than a second thickness that is a thickness between the fourth region of the third lens surface of the second lens and the fourth lens surface of the second lens.

6. The vehicular camera according to claim 3, wherein
the heater of the lens barrel includes a conducting wire portion including a first conducting wire end and a second conducting wire end opposite to the first conducting wire end,
the first conducting wire end of the conducting wire portion is connected to the heater,
the second conducting wire end of the conducting wire portion is electrically connected to the circuit board,
the resin member has a resin notch portion cut out from the resin inner surface to the resin outer surface in a part of the second resin surface, and
a part of the conducting wire portion is disposed in the resin notch portion of the resin member.

7. The vehicular camera according to claim 6, wherein
the conducting wire portion of the heater of the lens barrel passes between the inner surface and the outer surface of the first tubular portion of the lens barrel and is electrically connected to the circuit board.

8. The vehicular camera according to claim 1, further comprising:
a holding member made of resin, the holding member being positioned around the first end portion of the lens barrel and having a third tubular shape, wherein
the holding member having the third tubular shape includes
the first portion contacts the first end portion of the first tubular portion of the lens barrel and a peripheral edge of the first lens surface of the first lens, and
a second portion fixed to a part of the outer surface of the first tubular portion of the lens barrel.

9. The vehicular camera according to claim 8, further comprising:
an elastic member disposed between the first portion of the holding member and a first resin surface of the resin member and between the first lens side surface of the first lens and the inner surface of the first tubular portion of the lens barrel.

10. The vehicular camera according to claim 9, wherein
the elastic member is an O-ring.

11. The vehicular camera according to claim 1, wherein
the first lens of the lens barrel is a lens farthest from the imaging element, and
the heater of the lens barrel is able to heat the first lens of the lens barrel.

12. The vehicular camera according to claim 1, wherein
the heater of the lens barrel is a positive temperature coefficient (PTC) heater.

13. The vehicular camera according to claim 1, wherein
when the vehicular camera is disposed in a vehicle, the connector is electrically connected to a cable of the vehicle.

14. The vehicular camera according to claim 1, wherein
the circuit board connector is disposed on the second surface of the circuit board.

15. The vehicular camera according to claim 1, wherein
the circuit board includes a first circuit board and a second circuit board.

16. The vehicular camera according to claim 1, wherein
the connector is a coaxial connector including a signal terminal and a ground terminal.

17. The vehicular camera according to claim 1, wherein
the housing has a second tubular portion,
the housing includes
a third end portion of the second tubular portion, and
a fourth end portion of the second tubular portion opposite to the third end portion and disposed farther, than the third end portion of the second tubular portion, away from the first end portion of the first tubular portion of the lens barrel,
the third end portion of the second tubular portion supports the lens barrel, and
the connector is disposed in at least a part of the fourth end portion of the second tubular portion of the housing.

18. The vehicular camera according to claim 1, wherein
the housing is made of metal.
